(19) United States
(12) Patent Application Publication
(10) Pub. No.: US 2017/0237654 A1
(43) Pub. Date: Aug. 17, 2017

(54) FAST FAILOVER RECOVERY IN SOFTWARE DEFINED NETWORKS

(71) Applicant: Hewlett Packard Enterprise Development LP, Houston, TX (US)

(72) Inventors: Yoshio Turner, San Francisco, CA (US); Hyojoon Kim, Palo Alto, CA (US)

(21) Appl. No.: 15/500,549

(22) PCT Filed: Mar. 25, 2015
(86) PCT No.: PCT/US2015/022527

§ 371 Date: Jan. 31, 2017

(51) Int. Cl. H04L 12/703; H04L 12/801; H04L 29/06; H04L 12/753; H04L 12/741

(52) U.S. Cl. CPC H04L 45/28; H04L 45/48; H04L 45/54; H04L 69/03; H04L 47/12

(57) ABSTRACT

Examples relate to fast failover recovery in software defined networks. In some examples, a failure in a first primary tree is detected during data transmission of a data packet, where the primary tree is associated with a first group entry that is configured to direct each of the data packets to one of a first set of destination devices. A notification of the failure is sent to a remote controller device, where the remote controller device identifies backup trees of the route trees that does not include the failure. After the remote controller device updates the first group entry to be associated with a first backup tree that minimizes congestion, each of the data packets are sent to one of a second set of destination devices that are associated with the first backup tree.

### BACKGROUND

A software defined network (SDN) is a computer networking methodology that has distinct systems for deciding where traffic should be sent (i.e., control plane) and forwarding the traffic to the selected destinations (i.e., data plane). In contrast, typical networking devices (e.g., switches, routers, etc.) are integrated systems that both determine destinations and forward the traffic. Because the underlying infrastructure is abstracted, the infrastructure of an SDN can be centrally managed and programmed directly.

### BRIEF DESCRIPTION OF THE DRAWINGS

The following detailed description references the drawings, wherein:

FIG. 1 is a block diagram of an example networking device for providing fast failover recovery in a SDN;

FIG. 2 is a block diagram of an example system for providing fast failover recovery in a SDN;

FIG. 3 is a flowchart of an example method for execution by a networking device for providing fast failover recovery in a SDN;

FIG. 4A is a flowchart of an example method for execution by a controller device for resolving a failure in an SDN; and

FIG. 4B is a flowchart of an example method for execution by a controller device for determining subsets of destinations devices for a networking device;

FIG. 5 is a block diagram of an example SDN showing route trees for efficient routing.

### DETAILED DESCRIPTION

As discussed above, SDN allows networking infrastructure to be centrally managed and programmed. In an SDN network, every traffic flow managed by the controller is routed in the network by associating a forward action for the flow in every networking device on the flow path. Each forward action determines the networking device output port to be used for forwarding packets of that flow. In production networks, every networking device can have thousands of rules and the controller is configured to manage the rules of all networking devices. In this case, flow changes to accommodate traffic demand variations or network failures may have to update a large fraction of these rules in order to redirect traffic away from failed network segments or congested links. As the central controller recomputes numerous rules and pushes them to many networking devices, it is likely to become a choke point and cause network reconfiguration to take an excessive amount of time. Thus, the controller can add long latencies to the network reconfiguration time, and the limited processing power of existing networking device firmware can add significant latency to the recovery process.

Some SDN protocols (e.g., OPENFLOW®) introduced group tables which can be used to reduce the number of rules that need to be updated when routes need to be reconfigured. OPENFLOW® is a registered trademark of the Open Networking Foundation non-profit corporation, which is headquartered in Beaverton, Oreg. The OPENFLOW protocol provides centralized access to the forwarding plane of an SDN. The OPENFLOW protocol supports group tables as described herein.

For example, one type of group table is a fast failover table that defines a set of ordered buckets, where each bucket is associated with a port. In this example, each flow can be associated with a fast failover group, and packets are routed to the first live bucket in the group, where live indicates that the corresponding port is operational. The fast failover table allows for fast route changes in the event of local link/port failures. However, the fast failover table is unable to solve a global route reconfiguration problem that uses all paths available in the network instead of being restricted to a local route detour around the network failure.

In another example, another type of group table is an indirect group table that has a single bucket that can execute a set of actions associated with the group. A flow table entry can point to a group table entry, which then executes the actions associated with the group table entry. The group table provides a level of indirection when forwarding packets that reduces the number of rules that should be updated to reroute traffic.

Examples disclosed herein provide fast failover recovery in SDN's. For example, a failure in a first primary tree is detected during data transmission of a data packet, where the primary tree is associated with a first group entry that is configured to direct each of the data packets to one of a first set of destination devices. A notification of the failure is sent to a remote controller device, where the remote controller device identifies backup trees of the route trees that does not include the failure. After the remote controller device updates the first group entry to be associated with backup tree(s) that minimize congestion, each of the data packets are sent to one of a second set of destination devices that are associated with the first backup tree.

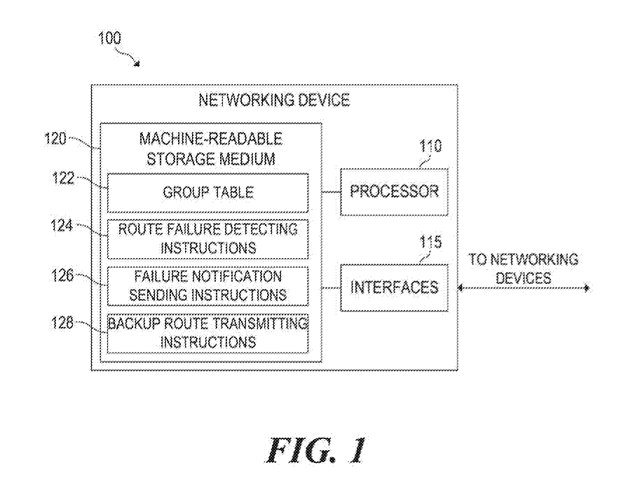

Referring now to the drawings, FIG. 1 is a block diagram of an example networking device 100 for providing fast failover recovery in a SDN. The example networking device 100 may be a switch, a router, a hub, a repeater, a bridge, or any other electronic device suitable for providing efficient routing in a SDN. In the embodiment of FIG. 1, networking device 100 includes processor 110, interfaces 115, and machine-readable storage medium 120.

Processor 110 may be central processing unit(s) (CPUs), microprocessor(s), and/or other hardware device(s) suitable for retrieval and execution of instructions stored in machine-readable storage medium 120. Processor 110 may fetch, decode, and execute instructions 124, 126, 128 to enable providing fast failover recovery in a SDN, as described below. As an alternative or in addition to retrieving and executing instructions, processor 110 may include electronic circuits comprising a number of electronic components for performing the functionality of instructions 124, 126, 128.

Interfaces 115 may include a number of electronic components for communicating with network device. For example, interfaces 115 may be wireless interfaces such as wireless local area network (WLAN) interfaces and/or physical interfaces such as Ethernet interfaces, Universal Serial Bus (USB) interfaces, external Serial Advanced Technology Attachment (eSATA) interfaces, or any other physical connection interface suitable for communication with the network device. In operation, as detailed below, interfaces 115 may be used to send and receive data to and from networking devices.

Machine-readable storage medium 120 may be any electronic, magnetic, optical, or other physical storage device that stores executable instructions. Thus, machine-readable storage medium 120 may be, for example, Random Access Memory (RAM), Content Addressable Memory (CAM), Ternary Content Addressable Memory (TCAM), an Electrically-Erasable Programmable Read-Only Memory (EEPROM), flash memory, a storage drive, an optical disc, and the like. As described in detail below, machine-readable storage medium 120 may be encoded with executable instructions for providing fast failover recovery in a SDN.

Group table 122 may be an indirect group table as described above that can execute a set of actions associated with a group table entry. Multiple entries in a forwarding table (not shown) can be associated with a group table entry so that there is a layer of abstraction between the forwarding table and the set of actions (i.e., a single change to the group change entry affects all the forwarding table entries associated with that group). The set of actions performed for a group table entry typically include a forward to port action. Further, in the case of a forward action, a group table entry can specify that traffic can be forwarded to one of multiple destination devices (i.e., subset of destination devices).

An entry in group table 122 can be associated with a route tree in a SDN. The route tree is a subset of the network topology that connect an arbitrary number of end-point devices. A flow consists of network traffic transferred as a sequence of data packets from one source end-point device to one destination end-point device. Each route tree defines a single path for a given flow, where the single path includes a sequence of links and switches that are used to route packets of that flow from the source to the destination end-point device. Specifically, the route tree may specify the networking devices (e.g., networking device 100) that a data transmission from a source end-point device should travel through to reach a destination end-point device. For example, the route tree may be generated as a minimum spanning tree according to Kruskal's algorithm.

Route failure detecting instructions 124 detect failed transmissions of data packets. For example, if a neighboring networking device of networking device 100 is offline, a packet forwarded to the neighboring networking device may return a notification that the transmission has failed. In another example, the connection between a neighboring networking device and networking device 100 may be faulty (e.g., bad network cable) thereby preventing the data transmission. In the event of data transmission failure, route failure detecting instructions 124 also collects metadata (e.g., error code, route tree identifier, etc.) related to the failed transmission.

Failure notification sending instructions 126 send a notification of the failed transmission to a controller device (not shown) of the SDN. The notification may include metadata describing the failed transmission so that the controller device can identify the cause of the failed transmission. In response to receiving the failure notification, the controller device may perform a congestion analysis to select a new route tree for all the route trees that contain the failed link or failed switch. In this case, controller device reconfigures a group table entry in group table 122 to be associated with the new route tree in all switch devices that are used by all route trees affected by the failure.

For each route tree affected by the failure new route tree(s) are selected. The new route tree(s) for each affected route tree can be distinct or not of the other new route trees. Backup route transmitting instructions 128 perform future data transmissions using the new route tree(s). Specifically, backup route transmitting instructions 128 may forward a packet to a port according to the updated group table entry in group table 122 so that the data transmissions travels through the new route tree(s). Because the new route tree(s) do not include the failure, the data transmissions can be successfully completed.

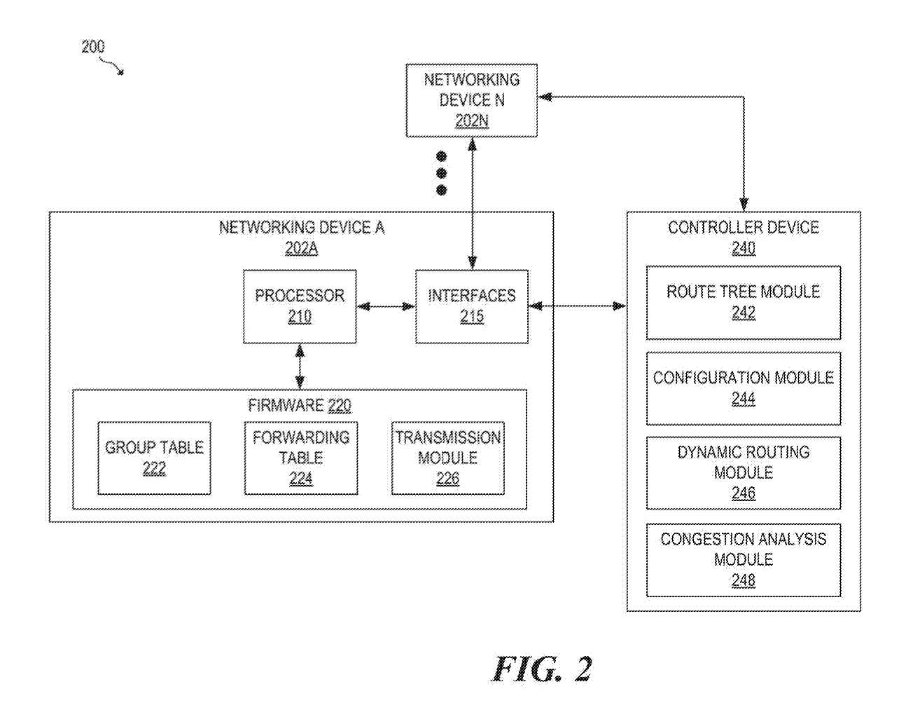

FIG. 2 is a block diagram of an example system 200 including networking devices (e.g., networking device A 202A, networking device N 202N) interacting with controller device 240 to provide a SDN. The components of the networking devices may be similar to the corresponding components of networking device 100 described with respect to FIG. 1. System 200 includes user devices networking devices (e.g., networking device A 202A, networking device N 202N) and controller device 240.

As illustrated, networking device A 202A may include processor 210, interfaces 215, and firmware 220. Processor 210 and interfaces 215 may be similar to the corresponding components of networking device 100 that are described above with respect to FIG. 1. In this example, interfaces 215 communicate with (e.g., networking device A 202A, networking device N 202N) and controller device 240. Firmware 220 may include a number of modules 222-226, where each of the modules may include a series of instructions encoded on a machine-readable storage medium, which may be similar to machine-readable storage medium 120 of FIG. 1, and executable by processor 210. In addition or as an alternative, each module may include hardware devices including electronic circuitry for implementing the functionality described below. Although the components of firmware 220 are described in detail below, additional details regarding an example implementation of firmware 220 are provided above in connection with instructions 122-128 of FIG. 1.

Group table 222 stores group table entries that define group for transmitting data in corresponding route trees. Each group table entry is associated with actions that typically include a forward to port action that transmits data along its corresponding route tree. For example, a group table entry may specify a forward to port action to transmit data to one of a number of destination devices (e.g., switches, routers, etc.). The route trees and group table 222 are configured by controller device as described below 240.

Forwarding table 224 stores forwarding table entries that define routes to destinations in the SDN. For example, a forwarding table entry may specify that packets destined for a particular destination end-point device should be forwarded to a port that is associated with a neighboring network device. In another example, a forwarding table entry may point to a group table entry, which can be used to route traffic from networking device A 202A.

Transmission module 226 forwards data packets to other devices in the SDN based on entries in group table 222 and forwarding table 224. Specifically, the destination of a packet may be used to query the forwarding table 224 to determine which port of networking device A 202A should be used to forward the packet. For example, transmission module 226 may use a group table entry to forward the packet upstream toward the root of a route tree associated with the group table entry. In another example, transmission module 226 may use a forwarding table entry to forward the packet downstream toward the destination end-point device of the route tree.

Transmission module 226 is also configured to detect transmission failures. In the event of a failure, transmission module 226 can collect metadata associated with the failure for sending in a transmission failure notification to controller device 240.

System 200 may include any number of networking devices (e.g., networking device A 202A, networking device N 202N) that are arranged in a variety of topologies. Each of the networking devices may be substantially similar to networking device A 202A. Specifically, each of the networking devices is compliant with an SDN protocol that supports indirect group tables (e.g., group table 222).

Controller device 240 may be a computing device that configured to manage an SDN including end-point devices (not shown) and networking devices (e.g., networking device A 202A, networking device N 202N). Controller device 240 may be, for example, a server, a networking device, or any other computing device suitable for managing traffic flow of an SDN. In this example, controller device 240 includes route tree module 242, configuration module 244, dynamic routing module 246, and congestion analysis module 248.

Route tree module 242 determines route trees for directing traffic in an SDN. Specifically, route tree module 242 creates a set of route trees that cover the network topologies and minimizes the number of links and switches shared among different trees, such that there is always a route tree available given an arbitrary single switch or link failure. Route tree module 242 also selects one of the route trees for each flow of traffic. A flow can be defined for a pair of source and destination end-point devices as an application TCP connection or other conventional ways of identifying a flow of data packets between a source and a destination device. In some cases, route tree module 242 allows an administrator to manually configure the route trees connecting the end-point devices. Each route tree can span all or only a subset of the end-point devices as long as all the route trees together span over all end-point devices. In other cases, route tree module 242 may automatically determine the route trees based on the topology on SDN. In either case, route tree module 242 is configured to determine route trees with minimal overlap to minimize the effect of failures in the SDN.

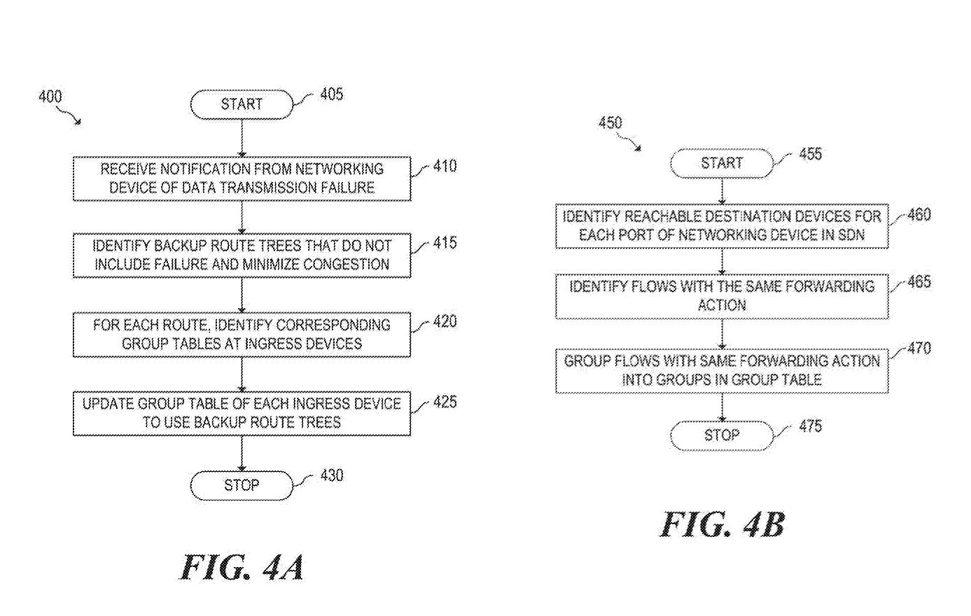

Configuration module 244 configures networking devices (e.g., networking device A 202A, networking device N 202N) with the route trees determined by route tree module 242. For example, a route tree can be processed by iterating through each networking device in the route tree and adding entries to the group table and/or forwarding table of the networking device according to the route tree. Configuration module 244 can also be configured to reduce the number of group table entries by grouping together flows that have the same forwarding action as described below with respect to FIG. 4B.

Dynamic routing module 246 reconfigures the flow of traffic in the SDN. For example, if there is a failure in the SDN, dynamic routing module 246 may replace route trees that include the failure with other route trees. In this example, dynamic routing module 246 can use congestion analysis module 248 to select backup routes that minimize congestion in the SDN.

Congestion analysis module 248 monitors and manages congestion in the SDN. Specifically, traffic in the SDN can be monitored at each of the networking devices (e.g., networking device A 202A, networking device N 202N, etc.) to identify portions of route trees that are congested. In this case, the congestion portions can be avoided when selecting a backup tree from a potential set of backup trees after a network failure. Further details related to congestions analysis are discussed below with respect to FIG. 4A.

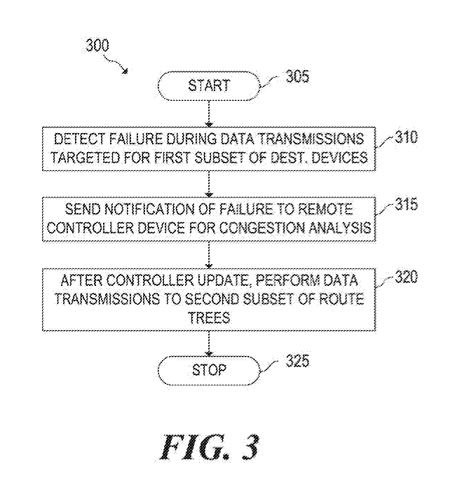

FIG. 3 is a flowchart of an example method 300 for execution by a networking device 100 for providing fast failover recovery in a SDN. Although execution of method 300 is described below with reference to networking device 100 of FIG. 1, other suitable devices for execution of method 300 may be used such as networking device A 202A of FIG. 2. Method 300 may be implemented in the form of executable instructions stored on a machine-readable storage medium, such as computer readable medium 120 of FIG. 1, and/or in the form of electronic circuitry.

Method 300 may start in block 305 and continue to block 310, where networking device 100 detects a failure during data transmissions targeted for a first subset of destination devices. In block 315, a notification of the failed transmissions is sent to a controller device of the SDN. The notification may include metadata describing the failed transmission so that the controller device can identify the cause of the failed transmission. In response to receiving the failure notification, the controller device may perform a congestion analysis to select backup route tree(s) for each of the route trees that include the failed link or failed switch.

In block 325, data transmission is resumed using the backup routes after the controller devices updates group tables on the networking device 100. The data transmission are now targeted at a second subset of route trees, which are associated with a backup route(s). Method 300 may then continue block 325, where method 300 may stop.

FIG. 4A is a flowchart of an example method 400 for execution by a controller device 240 for resolving a failure in an SDN. Although execution of method 400 is described below with reference to controller device 240 of FIG. 2, other suitable devices for execution of method 400 may be used. Method 400 may be implemented in the form of executable instructions stored on a machine-readable storage medium and/or in the form of electronic circuitry.

Method 400 may start in block 405 and continue to block 410, where controller device 240 receives a notification from a networking device of a data transmission failure. The notification may include information that can be used to identify a component or link in the SDN that is the cause of the failure. In block 415, controller device 240 identifies a set of backup trees that do not include the failure. Controller device 240 also selects a backup tree from the set that minimizes congestion.

Controller devices 240 only updates the corresponding group table entries at networking devices that are related to the failed route tree to convert the networking devices to use backup tree(s). To minimize congestion, controller device 240 computes appropriate weights for redistributing the traffic from the affected route to the backups in order to minimize network congestion introduced by the failover.

The goal of selecting backup route weights to minimize congestion is formulated as the linear optimization problem shown below in TABLE 1.

TABLE 1
Weight adjustment formulated as linear optimization model

| - Minimize z | |
|---|---|
| - Constraints: | |
| (1) | For every link e ∈ E: Loadₑ ≦ z. |
| | ${Load}_{e} = {\sum }_{r ∈ R} ( {\sum }_{s ∈ H} ( {\sum }_{b ∈ {B}_{r}} ( {\vec{w}}_{r , s , b} ( {\vec{L}}_{e , s , b}^{T} {\vec{T}}_{r , s} ) ) ) )$ |
| (2) | $For each ( r , s ) combination , {\sum }_{b ∈ {B}_{r}} {\vec{w}}_{r , s , b} = \vec{1} ,$ |
| (3) | For each (r, b, s, d1, d2) combination, |
| | If getGroupId (r, s, d1)==getGroupId (r, s, d2), |
| | \vec{w}_{r, s, b} [d1]==\vec{w}_{r, s, b}[d2] |

where r ∈ R, b ∈ Bᵣ, s ∈ H, d1 ∈ H, d2 ∈ H

Where z is the maximum load on a link, E is the set of all links in the topology, Loadₑ is the traffic amount at link e, R is the set of route trees computed so far, Bᵣ is the set of backup rout trees for a primary tree r, H is the set of all host-attached networking devices, \vec{T}_{r,s} is an H sized vector that includes the traffic amount from s to each destination host-attached networking device that uses route tree r, L_{e,s,r} is an H sized binary vector that is 1 if link e is included in the path between s and the list of destination host-attached networking devices that uses route tree r and 0 if not, \vec{w}_{r,s,b} is an H sized vector that includes weight setting distributions among backups in Bᵣ for each host attached networking device for backup b at networking device s when primary route tree r is used, and getGroupId(r,s,d) returns the group entry ID for route tree r, source networking device s, and destination networking device d.

The linear optimization objective is to minimize z, the maximum load among all links in the topology after traffic is distributed to the backup paths for every primary path that is disconnected by the failure. Constraint (1) states that z is the upper bound of loads on all links in the network. The load of a link after failure is determined by multiplying three values: the weight (in ratio) given to a backup (w), the traffic amount of the original flow (T), and a binary value that indicates whether the link is included in a backup route (L). Constraint (2) states that for each primary path and ingress networking device pair, the addition of the weights of all backup paths sums to 1. Constraint (3) presents the case where different egress networking devices are reachable by the same group table entry, due to the group minimization process described below with respect to FIG. 4B.

In some cases, networking device 240 fails over to multiple backup routes by using a select group table entry type. This entry type allows different actions to be performed on each unique flow based on selection weights. Specifically, a select type group table entry can have multiple action buckets, where each bucket specifies a list of actions. Each flow gets hash mapped to a bucket with probability proportional to an assigned bucket weight.

In block 420, for each backup route to be updated to address the network failure, networking device 240 identifies a corresponding group table of an ingress networking device. In block 425, networking device 240 updates the corresponding group tables to use the backup routes. Method 400 may then continue block 430, where method 400 may stop.

FIG. 4B is a flowchart of an example method 400 for execution by a controller device 240 for determining subsets of destinations devices for a networking device. Although execution of method 450 is described below with reference to controller device 240 of FIG. 2, other suitable devices for execution of method 450 may be used. Method 450 may be implemented in the form of executable instructions stored on a machine-readable storage medium and/or in the form of electronic circuitry.

Method 450 may start in block 455 and continue to block 460, where controller device 240 identifies reachable destination devices for each port of a networking device in the SDN. For example, the primary and backup route trees of the SDN can be used to identify reachable destination devices while in primary and backup operating modes for each port of the networking device.

In block 465, controller device 240 identifies flows with the same forwarding action based on the identified reachable destination devices. In particular, flows that share the same route tree (i.e., tagged with the same label) and forwarded to the same output port both before failure and after failure can share a group ID in the group table. TABLE 2 shows an example of forwarding rules at a host-attached ingress networking device for traffic to different host-attached egress networking device.

TABLE 2
Forwarding rules for ingress networking device

| Route Tree | Outport 1 | Outport 2 | Outport 3 |
|---|---|---|---|
| Primary | A, B, C, D | E, F | G, H, I |
| Backup 1 | G, H | A, B, C | D, E, F, I |
| Backup 2 | E, F | G, H | A, B, C, D, I |

In this example, a primary tree has two backup trees, and there are nine egress host-attached networking devices (A to I). TABLE 2 shows the forwarding action for each tree and egress networking device. Without group table reduction, the ingress networking device would use nine entries for the primary tree. In block 470, controller device 240 groups flows with the same forwarding action in the networking device's group table. In this example as shown in TABLE 3, the group table usage is reduced to five entries by grouping traffic to different egress networking devices that share the same forwarding action.

TABLE 3
Reduced group table

| Destination | Group ID |
|---|---|
| A, B, C | 10 |
| D | 11 |
| E, F | 12 |
| G, H | 13 |
| I | 14 |

Method 450 may then continue block 475, where method 450 may stop. Method 450 can be repeated by controller device 240 for each networking device in the SDN. TABLE 4 shows the pseudo code for reducing group table entries as described above.

TABLE 4
Pseudo code for group table reduction

| | |
|---|---|
| 1 | Minimization(r,Bᵣ); |
| 2 | for each v ∈ {r's host-attached switches}, do; |
| 3 | for each p ∈ outputPorts(v), do; |
| 4 | NewDstSet=GetReachableDst(p,r) |
| 5 | FindNewGroup(NewDstSet,Br,v) |
| 6 | |
| 7 | FindNewGroup(NewDstSet,Br,v); |
| 8 | // If NewDstSet becomes null , stop. |
| 9 | If NewDstSet=φ. |
| 10 | return |
| 11 | |
| 12 | // Maintain original set |
| 13 | OrgSet=NewDstSet |
| 14 | |
| 15 | // Start searching in backup's links |
| 16 | for each p ∈ outputPorts(v),do; |
| 17 | for each b ∈ Bᵣ,do; |
| 18 | // Find reachable DstSet for this p and b. |
| 19 | Tmp=NewDstSet ∩ GetReachableDst(p,b) |
| 20 | If Tmp ≠ φ; |
| 21 | NewDstSet=NewDstSet ∩ GetReachableDst(p,b) |
| 22 | |
| 23 | // Assign new group ID |
| 24 | assignNewGroupId(NewDstSet) |
| 25 | // Deal with remaining dst set |
| 26 | FindNewGroup(OrgSet-NewDstSet,Bᵣ,v) |

Given a primary route tree r and its backup route tree set Bᵣ, for each host-attached networking device v in r, a set of other host-attached networking device named NewDstSet, that are reachable through each output port p of v is computed (lines 1-4). Then the FindNewGroup method finds if the whole set or a subset of NewDstSet can be reached by using some output port in is backup routes. FindNewGroup method calls itself recursively until NewDstSet becomes empty (lines 8-10), which eventually occurs after all host-attached destinations are considered. The NewDstSet is first preserved (lines 12-13). Next, the destinations in NewDstSet are tested to determine whether the whole set or the subset of them are reachable through a particular output port using each of backup route trees (lines 15-21). If a group of destination host-attached networking devices are found (or have a single destination host-attached networking device), a new group table ID is assigned to the group (line 24), and then the method is called recursively with the remaining undealt set of destinations (lines 25-26).

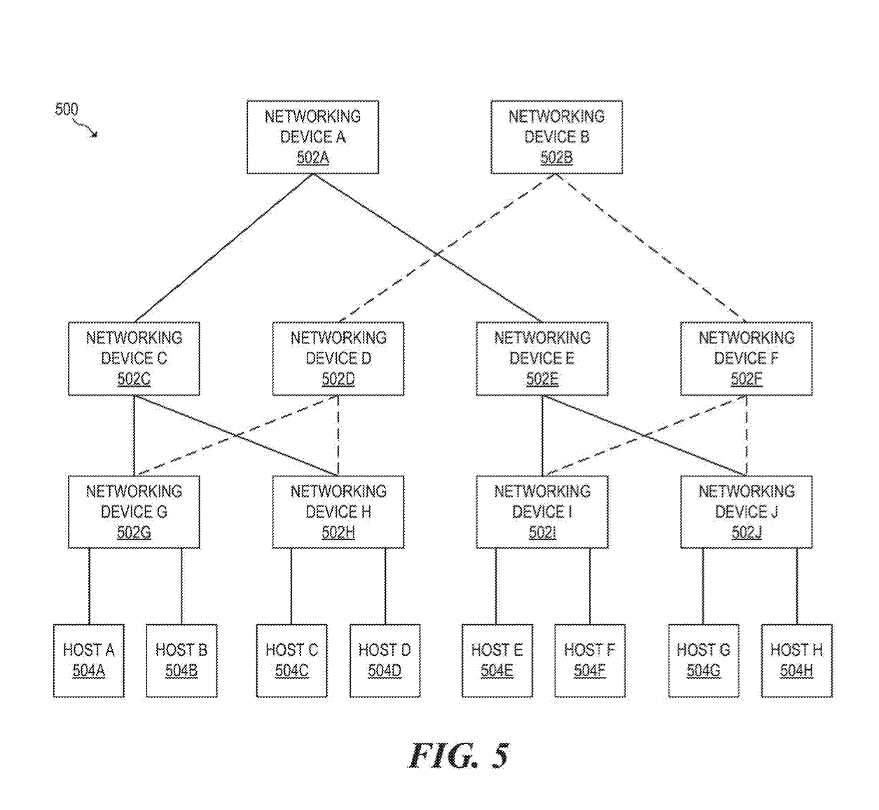

FIG. 5 is a block diagram of an example SDN 500 showing route trees for efficient routing. The SDN 500 includes network devices 502A-502J and hosts 504A-504H (i.e., end-point devices).

As shown by the solid connection lines, a first route tree in SDN 500 includes networking device A 502A, networking device C 502C, networking device E 502E, networking device G 502G, networking device H 502H, networking device I 5021, and networking device J 502J. As shown by the dashed connection lines, a second route tree in SDN 500 includes networking device B 502B, networking device D 502D, networking device F 502F, networking device G 502G, networking device H 502H, networking device I 5021, and networking device J 502J. The route trees have minimal overlap in their connections between network devices and connect each host to every other host, allowing traffic to be moved from the first tree to the second tree in the event of a failure.

For example, if the connection between networking device C 502C and networking device G 502G fails, traffic could no longer be routed on the first route tree from host A 504A to host H 504H. In this example, the second route tree could be associated with a group table entry in networking device G 502G to reroute the traffic through the second route tree.

The foregoing disclosure describes a number of examples for providing fast failover recovery in a SDN. In this manner, the examples disclosed herein facilitate fast failover recover in a SDN by using reduced group table entries and congestion analysis to perform the fast failover.

We claim:

1. A networking device for fast failover recovery in software defined networks, comprising:
a memory comprising an indirect group table with a first group entry that is associated with a first primary tree of a plurality of route trees in a software defined network, wherein the plurality of route trees is configured to minimize overlap between each of the plurality of route trees, and wherein the first primary tree is associated with a first set of destination devices in the software defined network;
a processor operatively connected to the memory, the processor to:
detect a failure in the first primary tree during data transmission of one of a plurality of data packets, wherein the first group entry is configured to direct each of the plurality of data packets to one of the first set of destination devices;
send a notification of the failure to a remote controller device, wherein the remote controller device identifies a plurality of backup trees of the plurality of route trees that does not include the failure; and
after the remote controller device updates the first group entry to be associated with a first backup tree of the plurality of backup trees that minimizes congestion, send each of the plurality of data packets to one of a second set of destination devices that are associated with the first backup tree.

2. The networking device of claim 1, wherein the software defined network uses the Open Flow communications protocol.

3. The networking device of claim 1, wherein the first backup tree is selected using a linear optimization to minimize the maximum load across the plurality of route trees according to a weight of each of the plurality of backup trees and prior traffic in the first primary tree.

4. The networking device of claim 1, wherein the first group entry is also associated with a second backup tree that includes a third set of destination devices.

5. The networking device of claim 1, wherein processor is further to:
after the remote controller device updates a second group entry to be associated with a second backup tree, send each of a second plurality of data packets to one of the first set of destination devices.

6. The networking device of claim 1, wherein the set of destination devices are created by the remote controller device by grouping destination devices that share a forwarding action.

7. A method for fast failover recovery in software defined networks, the method comprising:
receiving a notification of a failure in a first primary tree of a plurality of route trees from a networking device, wherein the plurality of route trees is configured to minimize overlap between each of the plurality of route trees, and wherein the first primary tree is associated with a first set of destination devices in a first group entry of the networking device;
identifying a plurality of backup trees of the plurality of route trees that does not include the failure; and
updating the first group entry to be associated with a first backup tree of the plurality of backup trees that minimizes congestion, wherein the networking device sends each of a plurality of data packets to one of a second set of destination devices that are associated with the first backup tree.

8. The method of claim 7, wherein the software defined network uses the OpenFlow communications protocol.

9. The method of claim 7, further comprising selecting the first backup tree using a linear optimization to minimize the maximum load across the plurality of route trees according to a weight of each of the plurality of backup trees and prior traffic in the first primary tree.

10. The method of claim 9, wherein the first group entry is also associated with a second backup tree that includes a third set of destination devices.

11. The method of claim 7, further comprising updating a second group entry of the networking device to be associated with a second backup tree, wherein the networking device sends each of a second plurality of data packets to one of the first set of destination devices.

12. The method of claim 7, wherein the set of destination devices are created by the remote controller device by grouping destination devices that share a forwarding action.

13. A non-transitory machine-readable storage medium encoded with instructions executable by a processor for fast failover recovery in software defined networks, the machine-readable storage medium comprising instructions to:
receive a notification of a failure in a first primary tree of a plurality of route trees from a networking device, wherein the plurality of route trees is configured to minimize overlap between each of the plurality of route trees, and wherein the first primary tree is associated with a first set of destination devices in a first group entry of the networking device;
identify a plurality of backup trees of the plurality of route trees that does not include the failure;
select a first backup tree using a linear optimization to minimize the maximum load across the plurality of route trees according to a weight of each of the plurality of backup trees and prior traffic in the first primary tree; and
update the first group entry to be associated with the first backup tree of the plurality of backup trees that minimizes congestion, wherein the networking device sends each of a plurality of data packets to one of a second set of destination devices that are associated with the first backup tree.

14. The non-transitory machine-readable storage medium of claim 13, wherein the first group entry is also associated with a second backup tree that includes a third set of destination devices.

15. The non-transitory machine-readable storage medium of claim 13, wherein the instructions are further to:
update a second group entry of the networking device to be associated with a second backup tree, wherein the networking device sends each of a second plurality of data packets to one of the first set of destination devices.
